(19) United States
(12) Patent Application Publication
(10) Pub. No.: US 2012/0315105 A1
(43) Pub. Date: Dec. 13, 2012

(54) PNEUMATIC SYSTEM FOR USE WITH DUNNAGE BAGS

(75) Inventors: Davis D. Freeman, Wisconsin Rapids, WI (US); Michael J. Radosevic, Wauwatosa, WI (US); Christopher W. Howell, Stoughton, WI (US)

(73) Assignee: Techmaster, Inc.

(21) Appl. No.: 13/155,787

(22) Filed: Jun. 8, 2011

(51) Int. Cl. B60P 7/16; F16K 15/20; B60P 7/06

(52) U.S. Cl. 410/119; 137/223

(57) ABSTRACT

A pneumatic system for use with dunnage bags includes a manifold configured to communicate pressurized air from a source and a station. The station includes a conduit coupled to the manifold and having an outlet configured to communicate the pressurized air with a dunnage bag. The station further includes a valve coupled to the conduit. The valve is biased closed and configured to open at a pressure corresponding to a predetermined fill pressure of the dunnage bag.

### BACKGROUND

The present disclosure relates generally to a pneumatic system for use with dunnage bags, which are generally used to limit movement of cargo during transportation of the cargo.

Dunnage bags may be used to secure the cargo of tractor trailer trucks, railroad cars, and other vehicles. Typically, the dunnage bags are positioned and inflated on the sides of the cargo, such as between the cargo and walls of the respective cargo container. Once inflated, the dunnage bags provide a secure fit for the cargo in the container, preventing unintended and undesired shifting, sliding, or other movement of the cargo during transportation.

Typically the dunnage bags are formed from paper and interiorly lined with plastic. Other dunnage bags may be formed entirely from plastic. Paper and plastic materials allow for inexpensive manufacturing and replacement of dunnage bags, however the materials are not generally designed to withstand pressures above around 10 to 15 pounds per square inch (psi). In a cargo container of tractor trailer truck, the dunnage bags are typically inflated to pressures of about 2 psi, substantially below the burst pressures at which the dunnage bags would fail. In a freight car of train, the dunnage bags may be inflated to pressures of 4 to 6 psi.

A typical cargo container for a tractor trailer truck may use twenty or more dunnage bags at a time, such as using ten or more on each side of the interior of the container. A trucker or cargo loader manually positions and inflates each dunnage bag to secure the cargo. Once positioned, the dunnage bags are then inflated, one at a time, by a pressure-regulated source. The supply pressure is typically regulated to a safe pressure for the dunnage bags, such as around 2 psi. Inflation at 2 psi may correspond to a relatively low air flow rate, and the task of securing the cargo by positioning and inflating each dunnage bag may be quite time consuming.

### SUMMARY

One embodiment of the invention relates to a pneumatic system for use with dunnage bags. The pneumatic system includes a manifold configured to communicate pressurized air from a source, and a station. The station includes a conduit that is coupled to the manifold and that has an outlet configured to communicate the pressurized air with a dunnage bag. The station further includes a valve coupled to the conduit. The valve is biased closed and configured to open at a pressure corresponding to a predetermined fill pressure of the dunnage bag.

Another embodiment of the invention relates to a pneumatic system for use with dunnage bags, which includes a manifold, a station, and an evacuation assembly. The manifold is configured to communicate pressurized air from a source. The station includes a conduit coupled to the manifold. The conduit has an outlet configured to communicate the pressurized air with a dunnage bag. The evacuation assembly is configured to deflate the dunnage bag by actively suctioning air from the dunnage bag through the manifold.

Yet another embodiment of the invention relates to a dunnage bag assembly. The dunnage bag assembly includes a dunnage bag and a check valve. The dunnage bag is configured to be inflated with pressurized air and is designed to limit movement of cargo in a cargo container during transportation of the cargo. The check valve is biased closed and configured to open when pressure in the dunnage bag reaches a predetermined fill pressure.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a tractor trailer truck according to an exemplary embodiment of the invention of the invention.

FIG. 2 is a perspective view of an interior of a cargo container according to an exemplary embodiment of the invention.

FIG. 3 is a perspective view of a portion of a pneumatic system for use with dunnage bags according to an exemplary embodiment of the invention.

FIG. 4 is a schematic diagram of a pneumatic system for use with dunnage bags in a first configuration according to an exemplary embodiment of the invention.

FIG. 5 is a schematic diagram of the pneumatic system of FIG. 4 in a second configuration.

FIG. 6 is a schematic diagram of the pneumatic system of FIG. 4 in a third configuration.

FIG. 7 is a schematic diagram of a pneumatic system for use with dunnage bags according to another exemplary embodiment of the invention.

FIG. 8 is a schematic diagram of a pneumatic system for use with dunnage bags according to yet another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

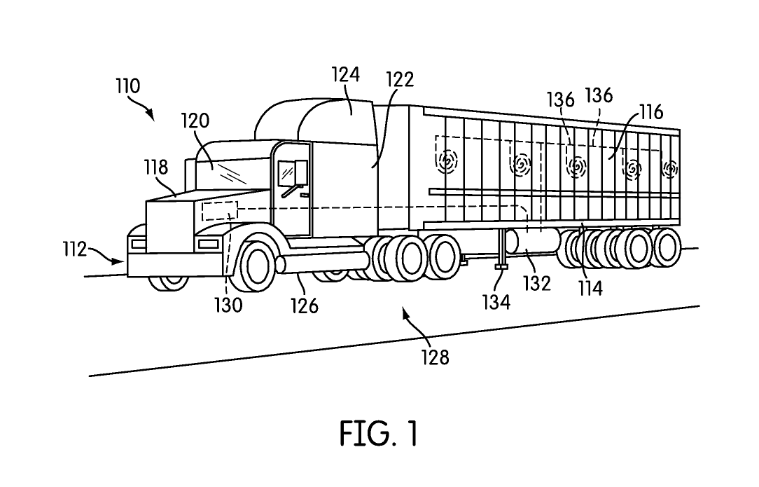

Referring to FIG. 1, a truck 110 includes a towing vehicle 112 (e.g., tractor) and a trailer 114 for hauling a container 116 (e.g., cargo container, shipping container, isotainer). In some embodiments, the towing vehicle 112 includes an engine compartment 118, a cabin 120, a sleeper 122, an air dam 124, and fuel tanks 126, among other components and features.

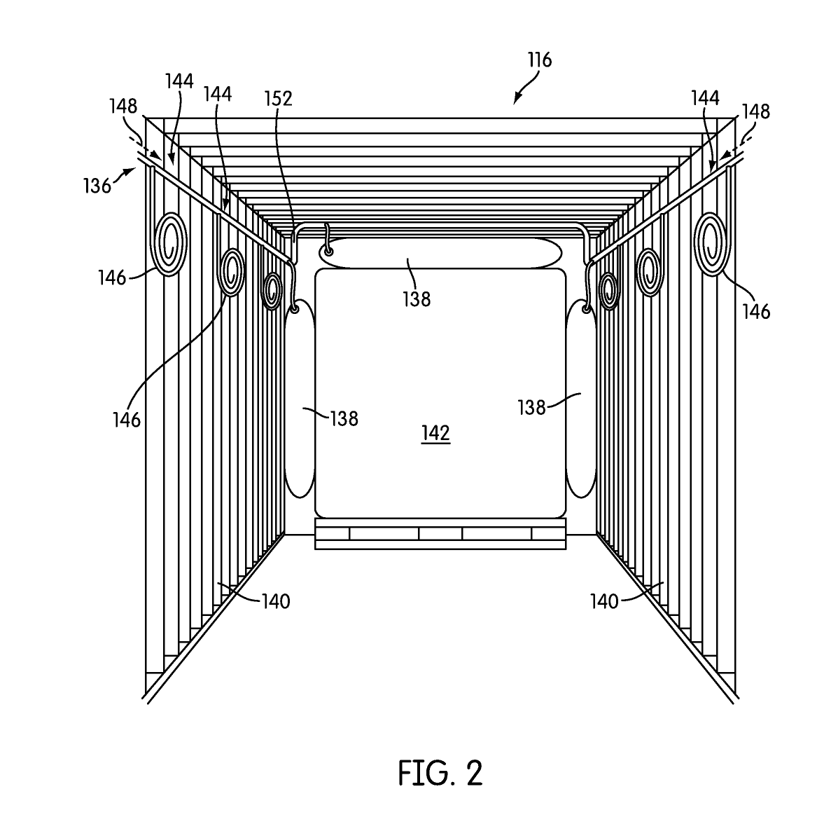

According to an exemplary embodiment, the trailer 114 is coupled to the towing vehicle 112 at a fifth wheel coupling 128. The trailer 114 may include landing gear 134 to support a container 116 when the trailer 114 is detached from the towing vehicle 112. The container 116 of the trailer 114 includes cargo space (see FIG. 2), which may be enclosed, refrigerated, sealed, etc. In other embodiments, a cargo container or portions thereof (e.g., pneumatic system 136) may be a part of freight car on a train, a shipping container on a ship, or incorporated in a hull of a ship or plane.

Still referring to FIG. 1, the truck 110 includes one or more air compressors 130. One air compressor 130 may be located in the engine compartment 118. In contemplated embodiments, other air compressors may be located below the trailer 114, in or below the towing vehicle 112. In some embodiments, the air compressor 130 is coupled to a receiver tank 132 (e.g., pressure vessel), which may in turn be coupled to air brakes, suspension components, tires, or to other portions of the truck 110 (e.g., pneumatic system 136) for operations thereof.

Referring now to FIG. 2, dunnage bags 138 are used with the cargo container 116 to support cargo 142 (e.g., boxes of goods on pallets). In some embodiments, the dunnage bags 138 may be positioned between the cargo 142 and walls 140 the container 116 to limit movement of the cargo 142 as the container 116 accelerates around turns, uphill, downhill, forward or backward during transportation. Dunnage bags 138 may also be placed between items of cargo 142, under or above cargo 142, or otherwise located.

Referring to FIGS. 1-3, the tractor trailer truck 110 includes a pneumatic system 136 for use with the dunnage bags 138. According to an exemplary embodiment, the pneumatic system 136 includes a manifold 152 (e.g., header) and one or more stations 144 (e.g., drops, branches) coupled to the manifold 152. According to various embodiments, the pneumatic system 136 may be used for rapid, simultaneous inflation and active deflation of the dunnage bags 138, over-pressure relief and low-pressure compensation of the dunnage bags 138 during transport, or for other purposes and combinations of such purposes.

In some embodiments, the pneumatic system 136 includes two rows 148 of stations 144 with at least three stations 144 in each row 148 (see FIG. 2). In some such embodiments, one of the rows 148 is positioned along one side wall 140 of the container 116, and the other row 148 is positioned along the opposite side wall 140. In other embodiments, a manifold may be mounted to a ceiling or floor of the cargo container 116 or in combinations of such places.

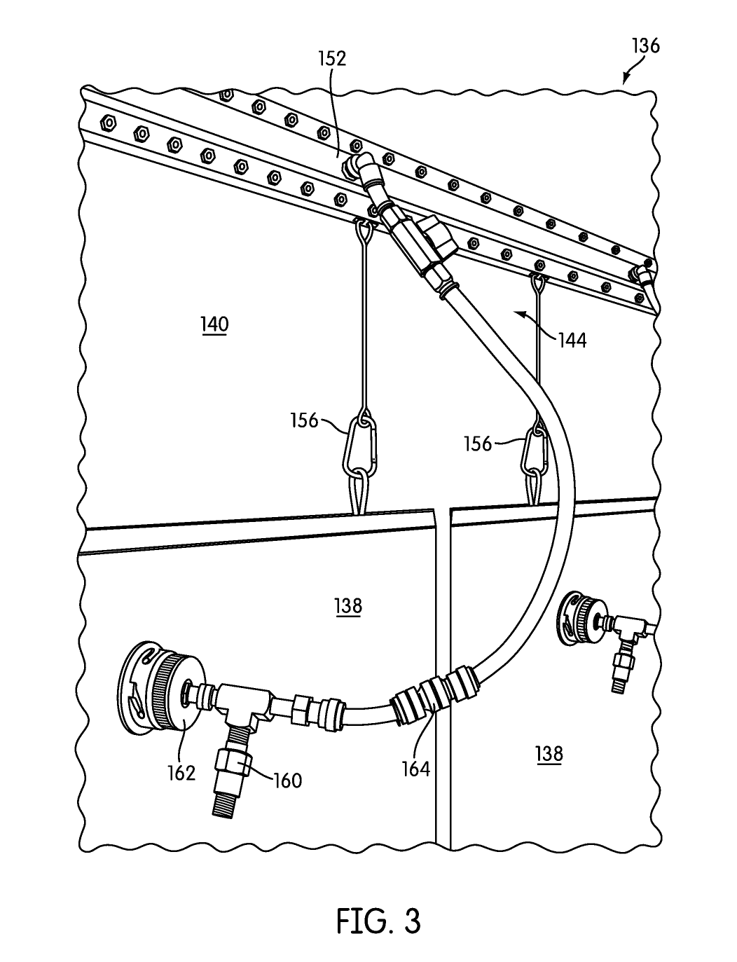

Referring specifically to FIG. 3, the manifold 152 may be formed from a rigid structure configured to be mounted to the interior wall 140, floor, ceiling, or other portion of the cargo container 116. In some embodiments, the manifold 152 is formed by extruding or molding a metal (e.g., aluminum) or hard plastic material. In some such embodiments, the manifold 152 includes bolt holes, hooks, welding surfaces, or other fastening features for attachment of the manifold 152 to the cargo container 116. The manifold 152 may include only a single passage for pressurized air, or may include more than one passage, such as high- and low-pressure passages.

The conduits 146 may be formed from a flexible hose material allowing an operator to maneuver the dunnage bags 138 into a desired location (within the reach of the conduit 146). Flexibility of the conduits 146 allows for maneuvering of the dunnage bags 138 as may be beneficial given a unique loading configuration or cargo geometry. In contemplated embodiments, the conduits 146 may be extendable or retractable or may be sufficiently long (e.g., at least five feet) so as to allow for a wide range of maneuverability and placement of the associated dunnage bag 138.

According to an exemplary embodiment, fasteners 156, such as clips or hooks, may extend from the manifold 152 or elsewhere to support the dunnage bags 138. The fasteners 156 may be positioned to attach to upper corners of the dunnage bags 138. In contemplated embodiments, fasteners may slide and lock into place on a rail, which allows for specific horizontal placement and support of the dunnage bags 138. In some embodiments, the fasteners may extend from a reel with an automatic rewind, allowing for vertical adjustment of the dunnage bags 138. In preferred applications, the manifold 152 is mounted to the container 116 above the load line so that the manifold 152 is readily accessible while cargo 142 is present in the container 116.

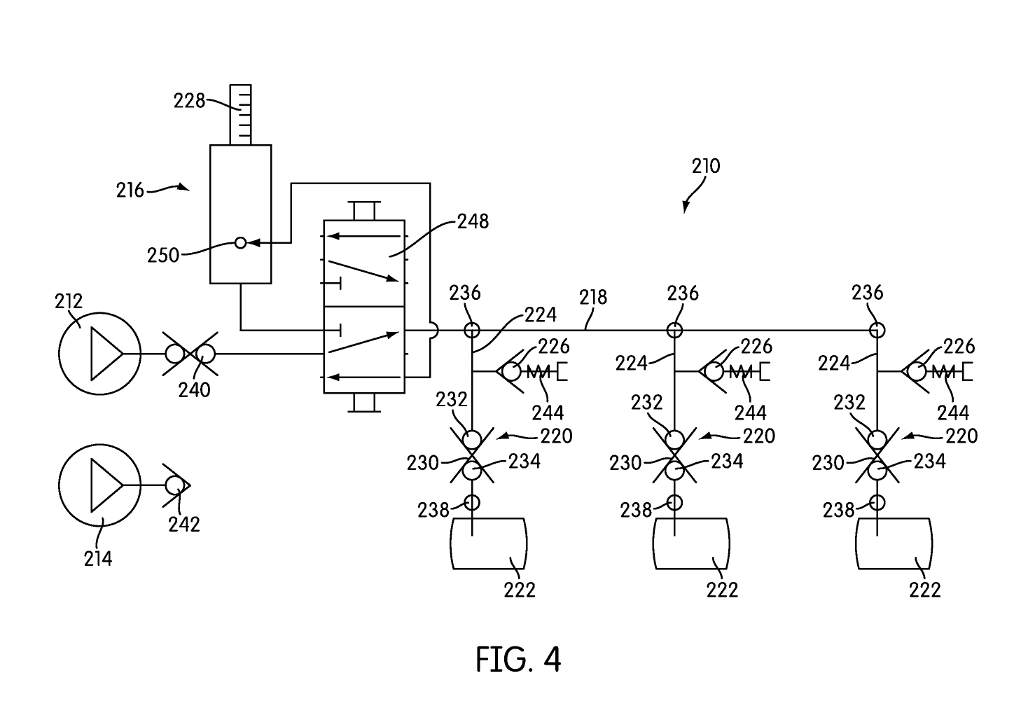

Referring to FIG. 4, a pneumatic system 210 includes a source 212 of pressurized air, a manifold 218 for communicating the air, and a station 220 coupled to the manifold for use with one or more individual dunnage bags 222. To inflate the dunnage bags 222, the manifold 218 communicates pressurized air to the dunnage bag 222 through a conduit 224 (e.g., fill line, hose, tube, port) of the station 220. In some embodiments, the pneumatic system 210 further includes an evacuation assembly 216 for rapidly deflating the dunnage bags 222. During loading of a cargo container (see, e.g., container 116 as shown in FIG. 2), the pneumatic system 210 may be used to rapidly inflate the dunnage bags 222, saving the time costs associated with manually filling each dunnage bag 222. Further, during unloading, the pneumatic system 210 may be used to rapidly deflate the dunnage bags 222.

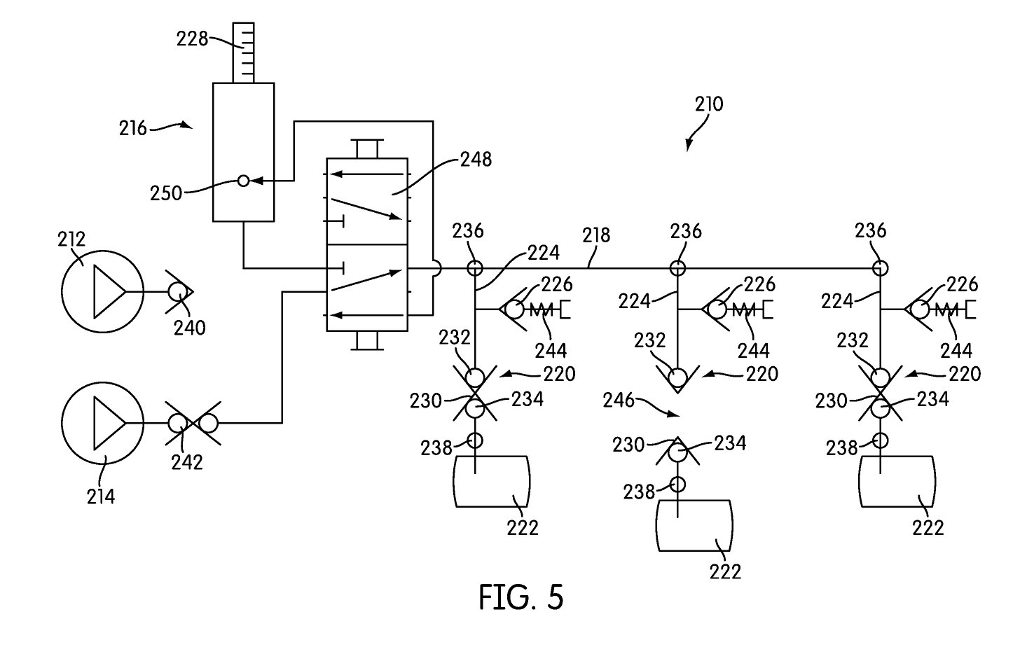

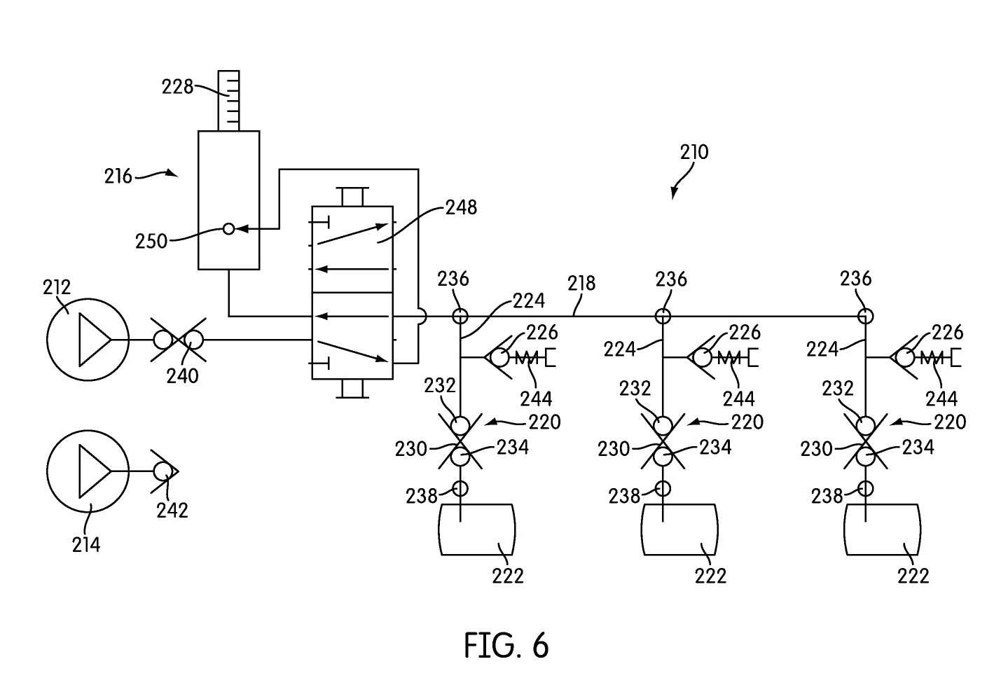

When pressure in the dunnage bag 222 is low, the pneumatic system 210 is configured to communicate pressurized air from the manifold 218, through the conduit 224, and to the dunnage bag 222 for inflation thereof (see FIG. 4). During transportation, the pneumatic system 210 is configured to maintain the desired fill pressure in the dunnage bags 222 by coupling the manifold 218 to an on-board, regulated source of pressurized air (see FIG. 5). When the pneumatic system 210 is actively evacuating the dunnage bag 222 with the evacuation assembly 216, the conduit 224 communicates pressurized air from the dunnage bag 222, through the manifold 218, and to an exhaust 228 (see FIG. 6).

Referring to FIGS. 4-6, the source 212 of pressurized air may be an air compressor associated with a docking station (e.g., loading dock). In other embodiments, a source 214 of pressurized air for the pneumatic system 210 may be a compressor carried by the tractor trailer truck (or other vehicle). In some embodiments, the pneumatic system 210 may be switched from connection with the source 212 to connection with the source 214 following initial inflation of the dunnage bags 222 at the docking station.

According to an exemplary embodiment, the pneumatic system includes a configuration of valving designed to control inflation of the dunnage bags 222. A valve 226 (e.g., relief valve) is used to prevent over-inflation of the dunnage bags 222. In some embodiments, the station includes a junction 236 (e.g., T-fitting) connecting the conduit 224 to the manifold 218, and another connector 238 fastening the conduit 224 to the dunnage bag 222. The connector 238 may include a threaded connector that locks and unlocks with a thumb-release button (see also connector 162 as shown in FIG. 3).

During use of the pneumatic system 210, as pressurized air is delivered to the dunnage bag 222 the dunnage bag 222 inflates and pressure in the dunnage bag 222 increases. Inflation of the dunnage bag 222, in turn, causes an increased pressure in the conduit 224. When the pressure in the conduit 224 reaches a magnitude corresponding to a predetermined fill pressure of the dunnage bag 222, a valve 226 opens to release additional pressurized air communicated through the conduit 224 (see also biased check valve 160 as shown in FIG. 3).

According to an exemplary embodiment, the valve 226 is a check valve that is oriented to allow air from the conduit 224 to pass out of the conduit 224 and not into the conduit 224. In some embodiments, the valve 226 is biased closed and configured to open when pressure in the conduit 224 reaches a magnitude corresponding to a predetermined pressure of the dunnage bag 222 (e.g., desired fill pressure). In some embodiments, the valve 226 is biased to open when the predetermined pressure in the dunnage bag 222 is in a range of 1 to 10 psi gage. In some such embodiments, the predetermined pressure is no greater than 5 psi gage.

In some embodiments, the valve 226 is a spring-loaded ball check valve. The magnitude of pre-loading of the spring 244 corresponds to a predetermined fill pressure in the dunnage bag 222. When the dunnage bag 222 is sufficiently inflated, back pressure in the conduit 224 provides a force on the ball that is sufficient to overcome the pre-loading by the spring 244 so that excess air is then vented through the valve 226 instead of filling the dunnage bag 222 beyond the predetermined fill pressure.

According to an exemplary embodiment, when the valve 226 is open, the valve 226 vents to atmosphere, which may include open air within or outside of the associated cargo container. In some embodiments, the valve 226 vents directly to atmosphere, while in other embodiments, the valve vents to another conduit that vents to atmosphere. In some embodiments, the valve may vent to a lower pressure manifold directed to a compressor for recirculation of the pressurized air in the pneumatic system.

Use of the valve 226 allows for the pressurized air to be communicated at supply pressures (e.g., 60 psi) well above the burst pressure (e.g., 15 psi) of the dunnage bag 222 because the valve 226 is automatically activated to release pressurized air once the dunnage bags 222 have been filled to the predetermined pressure (e.g., 2 to 3 psi). Accordingly, inflating the dunnage bags 222 with pressurized gas from the manifold 218 increases the speed at which the dunnage bags 222 may be inflated relative to inflation from a source supplying pressurized air at or proximate to a safe-inflation pressure (e.g., 6 psi or less) of the dunnage bags 222.

In contemplated embodiments, the valve 226 is a device other than a check valve, such as a pilot-operated ball valve, variable restrictor, directional-control valve, and/or another flow-control device. In some such embodiments, the valve 226 may be controlled directly as a function of pressure in the conduit, manifold, dunnage bag, or elsewhere in the system. In other such embodiments, the valve 226 may be controlled indirectly by a solenoid or other actuator that is operated as a function of pressure or another parameter, such as stress or strain, that may be related to pressure.

Referring to FIG. 5, in some embodiments, the manifold 218 is configured to be coupled to the source 214 during transport of the cargo, which may be the on-board compressor 130 shown in FIG. 1. A pressure regulator or another controller controls the pressure of air supplied to the manifold 218 during transport, limiting the pressure to the predetermined pressure (e.g., about 2 psi gage). If the truck drives to a higher altitude where atmospheric pressure is less, excess pressure in the dunnage bags may be vented through the valve 226. When the truck returns to a lower altitude, then pressurized air supplied by the source 214 may be used to return the dunnage bags 222 to the predetermined pressure. Such a pneumatic system 210 may also compensate for small leaks in the dunnage bags 222.

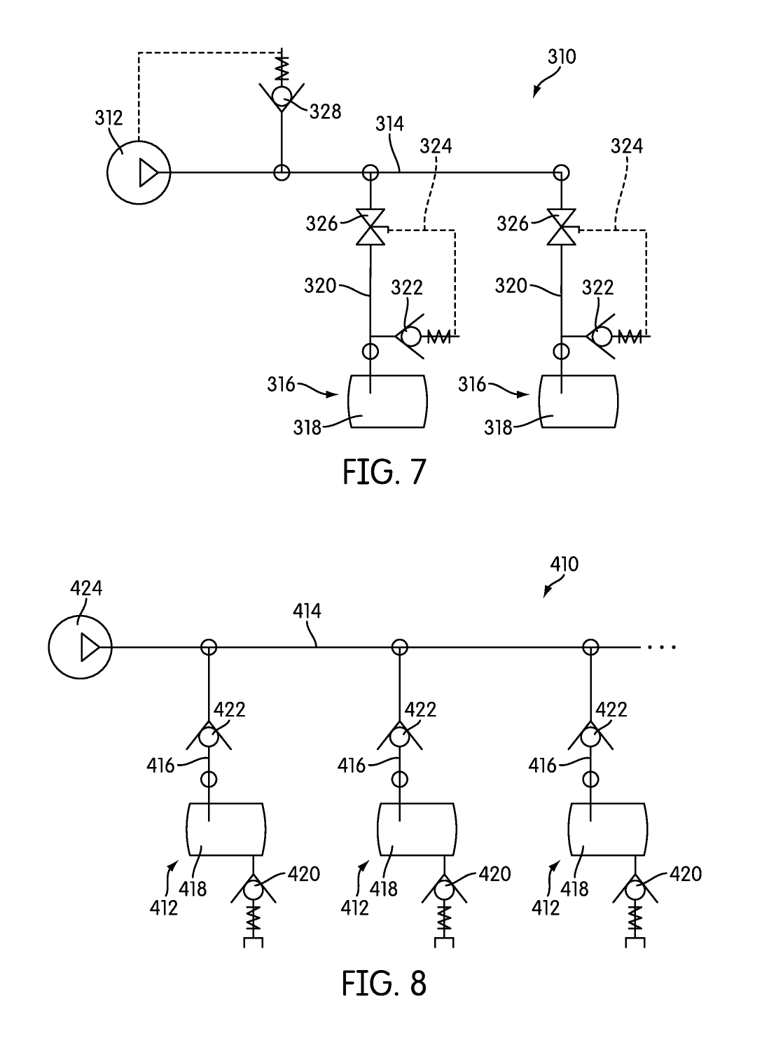

In other embodiments, once the dunnage bags 222 are inflated the source 212 may be decoupled from the pneumatic system 210 and the dunnage bags 222 are closed off, such as by a check valve in the conduit 146 (see, e.g., check valve 422 as shown in FIG. 8), a ball valve proximate to connection between the conduit and the manifold (see, e.g., valve 326 as shown in FIG. 7), a check valve integrated with the dunnage bag 222, or another gate or seal. In some embodiments, pneumatic system 210 may be locked down or deactivated during transport, or the dunnage bags 222 may also be temporarily disconnected from the pneumatic system 210.

According to an exemplary embodiment, the station 220 includes a coupler 230 configured to allow for separation of pneumatic communication between the dunnage bag 222 and the manifold 218 (see also coupler 164 as shown in FIG. 3). The coupler 230 may be a quick-connect coupler or another coupler, such as a threaded coupler. In some such embodiments, the coupler includes male and female connectors 232, 234, one on each part of the conduit 224.

In some embodiments, one or both of the connectors 232, 234 of the coupler 230 may include an integrated check valve. In some such embodiments, the check valves of the connectors 232, 234 are activated when the coupler 230 is disconnected in order to prevent air from passing through the connectors 232, 234 (see disconnected coupler 246 as shown in FIG. 5). The same check valves are held open when the coupler 230 is connected so as to allow flow through the conduit 224. In some embodiments, disconnecting the coupler 230 may be used to disable the station 220 when the associated dunnage bag 222 is not needed so that the pressurized air is directed to other stations 220 of the pneumatic system 210.

A similar coupler 240, 242 may be used between the sources 212, 214 and the manifold 218. When either of the sources 212, 214 are disconnected from the manifold 218, then a check valve may be activated to prevent flow of pressurized air from the manifold 218. Connecting either source 212, 214 with the couplers 240, 242 may then hold open the associated check valves.

Referring to FIGS. 4 and 6, the evacuation assembly 216 may include a two-way directional-control valve 248, a Venturi configuration 250, and the exhaust 228. The directional-control valve 248 directs the flow of pressurized air from the source 212 either to the manifold 218 for communication with the stations 220, or to the Venturi configuration 250. In some embodiments, the directional-control valve 248 is manually operated. In other embodiments, the directional-control valve is automated or otherwise controlled, such as by an operator of the truck pressing a button to actuate a solenoid to actuate the directional-control valve.

When the evacuation assembly 216 is in operation, the directional-control valve 248 directs a flow of pressurized air from the source 212 (or another source) across an opening in the Venturi configuration 250 that is coupled to the manifold 218. Movement of air normal to the opening provides low pressure at the opening, which is communicated to the dunnage bags 222 through the conduits 224 and manifold 218. Accordingly, the Venturi configuration 250 draws air from the dunnage bags 222, rapidly and fully deflating the dunnage bags 222, which facilitates quick unloading of the associated cargo.

In other contemplated embodiments, an evacuation system includes a pump that provides a vacuum, such as a centrifugal pump or a positive-displacement pump, to actively suction air from the dunnage bags 222 through the conduit 224 and manifold 218. In some such embodiments, the manifold 218 is coupled to the intake of the same compressor that may be used to provide pressurized air (from the outlet thereof) to inflate the dunnage bags 222.

Referring to FIG. 7, a pneumatic system 310 includes a source 312 of pressurized air, a manifold 314, and stations 316 for use inflating dunnage bags 318. Each station 316 includes a conduit 320 configured to deliver air from the manifold 314 to a dunnage bag 318. A biased check valve 322 coupled to the conduit 320 may be used to prevent over-inflation of the dunnage bag 318 by opening when the dunnage bag 318 has reached a desired fill pressure.

In some embodiments, a pilot 324 from the check valve 322 is directed to a shutoff valve 326 that closes the conduit 320. The check valve 322 may also be configured to vent air that is not used in the pilot 324 to atmosphere. In some embodiments, the shutoff valve 326 is a ball valve. In other embodiments, the shutoff valve is a shuttle valve or another type of valve. The shutoff valve 326 may be used in conjunction with or in place of a coupler to disable the station (see, e.g., coupler 230 as shown in FIG. 4).

In contemplated embodiments, the signal provided by the pilot 324 may be countered by a second signal associated with pressure in the dunnage bag or conduit. For example, if pressure in the dunnage bag or conduit exceeds the predetermined pressure, excess pressurized air will vent and the pilot signal will direct the shutoff valve 326 to close, shutting off the flow of air to the dunnage bag 318 from the manifold 314. However, if pressure in the dunnage bag 318 or conduit 320 falls below a second predetermined pressure (e.g., 0.5 psi less than the first predetermined pressure), then the second signal will direct the shutoff valve 326 to open. Operating the pneumatic system 310 based upon pressure in the conduit 320 may allow for use of standard dunnage bags with the pneumatic system 310.

According to an exemplary embodiment, the pneumatic system further includes a biased check valve 328 coupled to the manifold 314. When inflating the dunnage bags 318, as all of the shutoff valves 326 close, pressure on the manifold 314 will increase to a predetermined pressure at which the biased check valve 328 will open to provide a signal to turn off the source 312. The biased check valve 328 may also be configured to vent excess pressurized air to atmosphere. In some embodiments, the biased check valve 328 coupled to the manifold 314 is configured to initially open at a greater pressure than the biased check valves 322 coupled to the conduits 320 of the stations 316.

Referring to FIG. 8, a pneumatic system 410 includes a source 424 of pressurized air configured to supply the air to stations 412 coupled to a manifold 414. Each station 412 includes a conduit 416 that extends from the manifold 414 and is configured to connect to one or more dunnage bags 418. In some embodiments, a check valve 422 is positioned along the conduit 416 to prevent air from flowing backward to the manifold 414. According to an exemplary embodiment, each dunnage bag 418 includes a valve 420 integrated therewith. In contemplated embodiments the valve 420 includes a biased spring that is configured to be adjusted (e.g., tightened, compressed) to change the pressure at which the relief valve opens.

Accordingly, an operator may set the valve 420 to a predetermined pressure for filling the dunnage bag 418. Once pressure in the dunnage bag 418 reaches the predetermined pressure, the valve 420 opens and vents additional air to the atmosphere. When all dunnage bags 418 coupled to the manifold 414 have been filled, an operator may turn off the source 424 of pressurized air and decouple the source 424 from the pneumatic system 410. In other embodiments the valve is coupled to the conduit (see, e.g., valve 226 as shown in FIG. 4).

Although shown, according to the exemplary embodiments, for use with inflation of the dunnage bags, the present disclosure may be applied to a broad range of pneumatic control applications and inflation tasks, and may be used with various inflatable items. In some embodiments, a pneumatic system may be used to control rapid inflation of inflatable shelters, rafts, air mattresses, dirigibles, etc. In some embodiments, fluids other than air may be used and controlled by a system embodying technology described herein.

The construction and arrangements of the pneumatic system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Components shown for use with some embodiments may be mixed and matched with other embodiments, such as the evacuation assembly 216 shown in FIG. 4 coupled to the pneumatic system 310 of FIG. 7, for example. Other substitutions, modifications, changes and omissions may also be made in the design, operating conditions and arrangement of the various exemplary embodiments without departing from the scope of the present invention.

What is claimed is:

1. A pneumatic system for use with dunnage bags, comprising:
a manifold configured to communicate pressurized air from a source; and
a station, comprising:
a conduit coupled to the manifold and comprising an outlet configured to communicate the pressurized air with a dunnage bag;
a valve coupled to the conduit, wherein the valve is biased closed and configured to open at a pressure corresponding to a predetermined fill pressure of the dunnage bag.

2. The pneumatic system of claim 1, wherein the valve is a check valve.

3. The pneumatic system of claim 1, wherein the predetermined fill pressure is in a range of 1 to 10 psi gage.

4. The pneumatic system of claim 3, wherein the predetermined fill pressure is no greater than 5 psi gage.

5. The pneumatic system of claim 1, wherein the valve vents to atmosphere when open.

6. The pneumatic system of claim 1, further comprising the dunnage bag, wherein the dunnage bag is fastened to the outlet of the conduit.

7. The pneumatic system of claim 6, wherein the manifold comprises fasteners configured to attach to corners of the dunnage bag.

8. The pneumatic system of claim 1, wherein the manifold includes only a single passage for communication of the pressurized air.

9. The pneumatic system of claim 8, wherein the manifold is primarily formed from a rigid material configured to be mounted to an interior surface of a cargo container and the conduit comprises a flexible hose.

10. The pneumatic system of claim 1, further comprising second and third stations substantially similar to the station but extending from different positions along the manifold, whereby the pneumatic system is configured to simultaneously communicate pressurized air with at least three dunnage bags.

11. The pneumatic system of claim 1, further comprising a coupler positioned along the conduit, whereby the dunnage bag is configured to be disconnected from the manifold to disable the station.

12. The pneumatic system of claim 11, wherein the coupler comprises opposing connectors and a check valve integrated with one of the connectors, wherein the check valve is configured to inhibit air flow from the manifold when the connectors are disconnected.

13. The pneumatic system of claim 1, further comprising a coupler positioned between the source and the station, whereby the source is configured to be disconnected from the manifold and substituted by another source.

14. The pneumatic system of claim 13, wherein the coupler comprises opposing connectors and a check valve integrated with one of the connectors, wherein the check valve is configured to inhibit air flow from the manifold when the connectors are disconnected.

15. A pneumatic system for use with dunnage bags, comprising:
a manifold configured to communicate pressurized air from a source;
a station comprising a conduit coupled to the manifold, the conduit comprising an outlet configured to communicate the pressurized air with a dunnage bag; and
an evacuation assembly configured to deflate the dunnage bag by actively suctioning air from the dunnage bag through the manifold.

16. The pneumatic system of claim 15, wherein the evacuation assembly is configured to direct a flow of air in a direction normal to an opening coupled to the manifold thereby providing a low pressure at the opening.

17. The pneumatic system of claim 15, further comprising a directional-control valve configured to direct pressurized air from the source to either the station or the evacuation assembly.

18. The pneumatic system of claim 17, wherein the directional-control valve is configured to be manually operated.

19. A dunnage bag assembly, comprising:
a dunnage bag configured to be inflated with pressurized air and to limit movement of cargo in a cargo container during transportation of the cargo; and
a check valve biased closed and configured to open when pressure in the dunnage bag reaches a predetermined fill pressure.

20. The dunnage bag assembly of claim 19, wherein the predetermined fill pressure is in a range of 1 to 10 psi gage.
